(19) United States
(12) Patent Application Publication
(10) Pub. No.: US 2016/0290190 A1
(43) Pub. Date: Oct. 6, 2016

(54) ENGINE

(71) Applicant: FUJI JUKOGYO KABUSHIKI KAISHA, Tokyo (JP)

(72) Inventor: Kentaro KAIZUMI, Tokyo (JP)

(21) Appl. No.: 15/067,630

(22) Filed: Mar. 11, 2016

(30) Foreign Application Priority Data
Mar. 31, 2015 (JP) 2015-070774

(51) Int. Cl. F01M 11/00; F02P 1/00

(52) U.S. Cl. CPC F01M 11/0004; F02P 1/005; F01M 2011/0041

(57) ABSTRACT

An engine includes a crankcase that houses a crankshaft, an oil pan that is provided at a lower part of the crankcase and reserves an oil, a magneto chamber that is provided adjacent to one of ends of the crankcase in a rotation axis direction of the crankshaft, houses a magneto, and reserves an oil in a lower part of the magneto chamber, and a sub oil pan that is disposed next to the oil pan, under the magneto chamber and adjacent to the magneto chamber via a partition wall, and is capable of letting in an oil from the oil pan.

### CROSS-REFERENCE TO RELATED APPLICATIONS

The present application claims priority from Japanese Patent Application No. 2015-070774 filed on Mar. 31, 2015, the entire contents of which are hereby incorporated by reference.

### BACKGROUND

1. Technical Field

The present invention relates to wet-sump engines, and in particular, relates to an engine that can increase the resistance to inclination and efficiently cool a magneto.

2. Related Art

A wet-sump engine generally used for an off-road vehicle such as a four-wheeled ATV reserves lubricant oil in an oil pan provided at the lower part of a crankcase, and uses an oil pump to pump oil sucked up from a strainer disposed inside the oil pan to each part that needs lubricating.

When such a wet-sump engine is inclined due to bad roads, a part of the surface of the liquid (oil) in the oil pan is relatively inclined with respect to the engine.

If the surface of the oil then comes into contact with a rotary part such as a crankshaft, the oil is scooped up and turns into mist in the engine, causing a problem such as oil spout from a breather.

Meanwhile, a multi-cylinder engine for an off-road vehicle requires much oil, but is difficult to have an oil pan enlarged in depth from the perspective of the mountability and traveling performance.

In contrast, a smaller amount of oil leads to a shorter maintenance cycle, losing user convenience.

Although it is possible to restrain the overall height of an engine and to secure an enough amount of oil in a dry-sump system, in which a reservoir tank is provided independently of a crankcase, the dry sump system increases the number of parts and complicates the structure, resulting in increased weight and more costs.

It is thus desired to both reserve an enough amount of oil and increase the resistance to inclination in the wet-sump system by another method.

As a conventional technique related to an oil pan in a wet-sump engine, for example, Japanese Unexamined Patent Application Publication (JP-A) No. 2006-316627 describes a sub oil pan provided to restrain the number of parts and to increase the amount of oil to fill the oil pan with without any reinforcing structure, the sub oil pan communicating with the oil pan via a bulge projecting from the side of the oil pan.

JP-A No. 2003-176754 describes the structure of an oil pan of an engine, the oil pan having its volume enlarged using dead space created by forming an extension at the lower part of a transmission case adjacent to a crankcase, the extension protruding below an auxiliary drive pulley.

JP-A No. 2010-59924 describes a saddle-ride type four-wheeled vehicle including a first reservoir at the lower part of a crankcase, and a second reservoir next to the first reservoir with the bottom of the second reservoir positioned above the first reservoir for the purpose of, for example, securing lubrication when inclined in the axial direction of a crank.

JP-A No. 2003-41919 describes an oil pan for an engine, the oil pan reserving an enough amount of oil and restraining the overall height of the engine by forming a laterally projecting part from a point where the oil pan is joined to a crankcase at a site corresponding to the lower part of an auxiliary machine.

### SUMMARY OF THE INVENTION

In an engine that contains, in a magneto chamber which communicates with the interior of a crankcase, a magneto mechanism for generating direct-current power with a rotor magnet which rotates together with a crankshaft and a stator coil which is fixed to the crankcase, a projection on the rotor magnet scoops up and cools oil reserved in the lower part of the magneto chamber.

The magneto, however, has a high temperature while the engine is driven, and especially the temperature of the stator coil reaches a high temperature of, for example, 170 degrees Celsius or more in some cases.

The magneto needs more efficiently cooling for the reliability and durability.

In view of the above-described problems, an object of the present invention is to provide an engine that can increase the resistance to inclination and efficiently cool a magneto.

The present invention solves the above-described problems by applying the following solutions.

A first aspect of the present invention provides an engine including: a crankcase that houses a crankshaft; an oil pan that is provided at a lower part of the crankcase and reserves an oil; a magneto chamber that is provided adjacent to one of ends of the crankcase in a rotation axis direction of the crankshaft, houses a magneto, and reserves an oil in a lower part of the magneto chamber; and a sub oil pan that is horizontally offset with respect to the oil pan, is disposed under the magneto chamber and adjacent to the magneto chamber via a partition wall, and is capable of letting in an oil from the oil pan.

A part of the sub oil pan may be integrated with a magneto cover that constitutes an outer wall of the magneto chamber, and another part of the sub oil pan may be integrated with the crankcase.

### BRIEF DESCRIPTION OF THE DRAWINGS

FIG. 1 illustrates a cross section of an engine according to an implementation to which the present invention is applied, and is a cross-sectional view taken along a plane including a crankshaft axis and a cylinder axis (arrow cross-sectional view taken along I-I in FIG. 2);

FIG. 2 is an arrow cross-sectional view taken along II-II in FIG. 1;

FIG. 3 is an arrow cross-sectional view taken along III-III in FIG. 1; and

FIG. 4 is an arrow cross-sectional view taken along IV-IV in FIG. 3.

### DETAILED DESCRIPTION

Hereinafter, a preferred implementation of the present disclosure will be described in detail with reference to the appended drawings. Note that, in this specification and the appended drawings, structural elements that have substantially the same function and structure are denoted with the same reference numerals, and repeated description of these structural elements is omitted.

The present invention achieves an object of providing an engine that can increase the resistance to inclination and efficiently cool a magneto, by disposing, adjacent to the bottom of a magneto chamber, a sub oil pan projecting toward the side of an oil pan, using the sub oil pan as a buffer for the inclined engine, and cooling oil having a high temperature in the magneto chamber with oil in the sub oil pan.

### Implementation

An engine according to an implementation to which the present invention is applied will be described below.

The engine according to the implementation is, for example, a transverse engine mounted on an ATV, which is a four-wheeled off-road vehicle, as a traveling power source.

The engine according to the implementation is a 4-stroke water-cooled parallel 2-cylinder 4-valve DOHC gasoline engine.

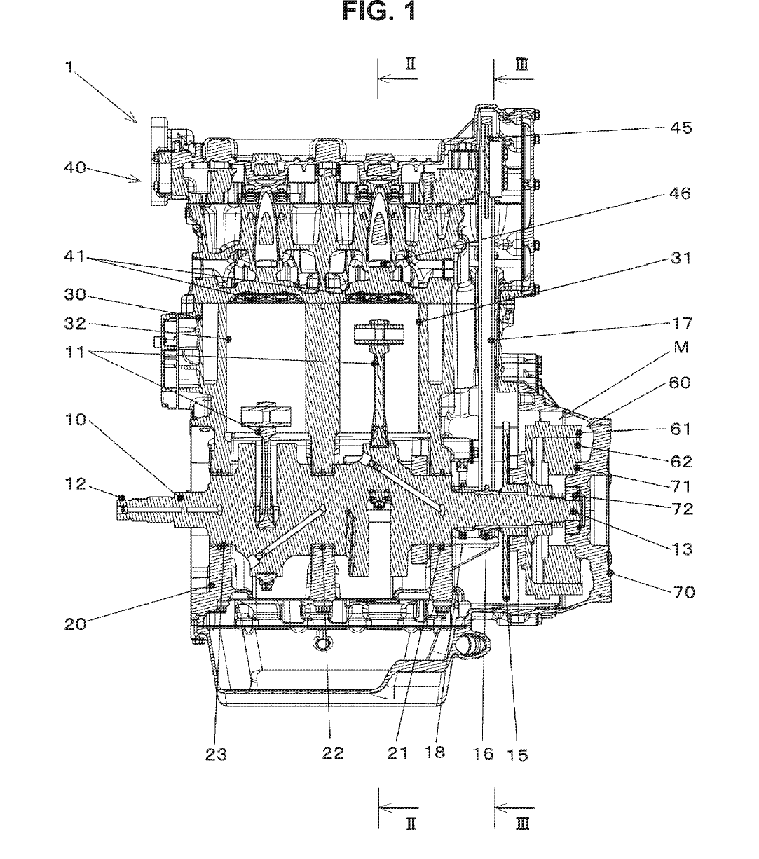

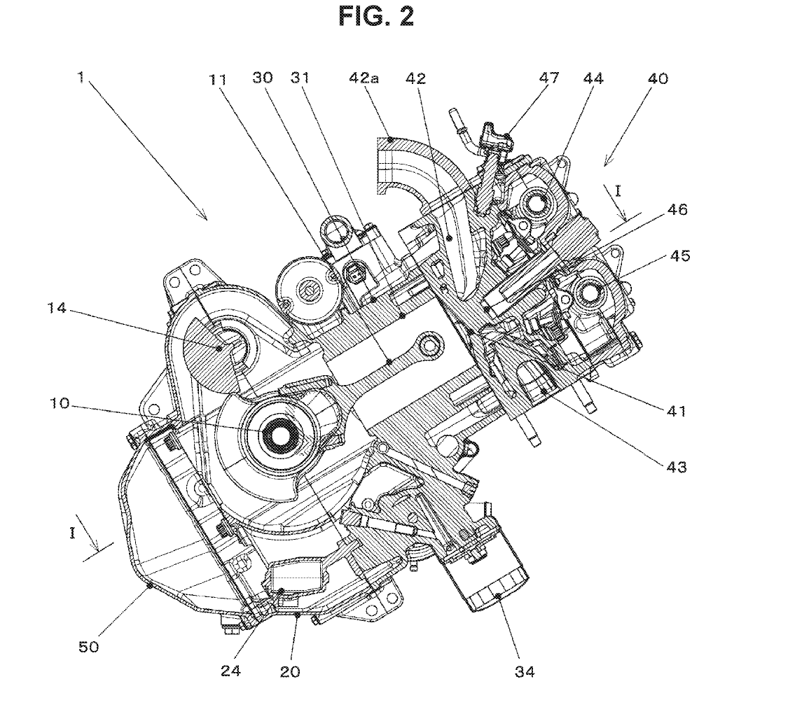

FIG. 1 illustrates a cross section of the engine according to the implementation, and is a cross-sectional view (arrow cross-sectional view taken along I-I in FIG. 2) taken along a plane including a crankshaft axis and a cylinder axis.

FIG. 2 is an arrow cross-sectional view taken along II-II in FIG. 1.

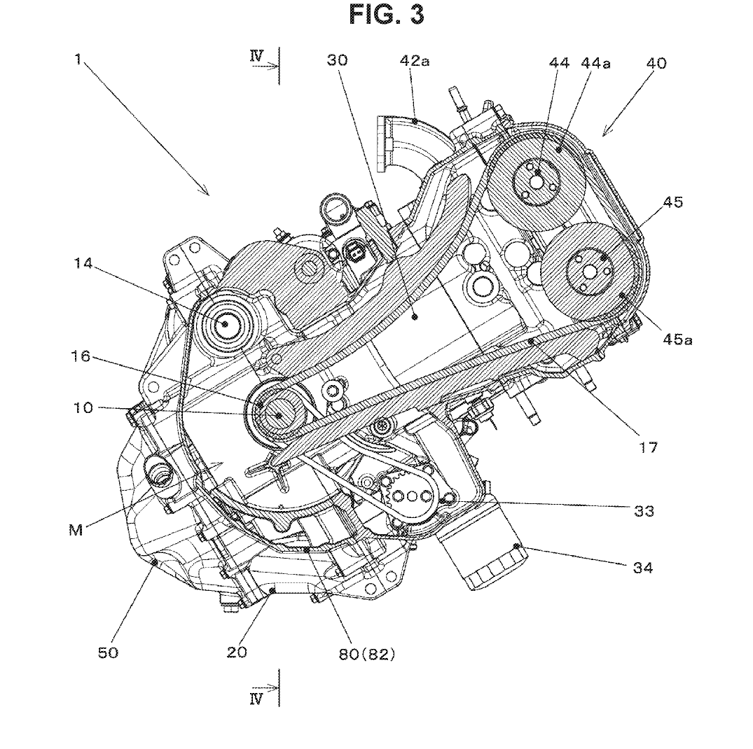

FIG. 3 is an arrow cross-sectional view taken along III-III in FIG. 1.

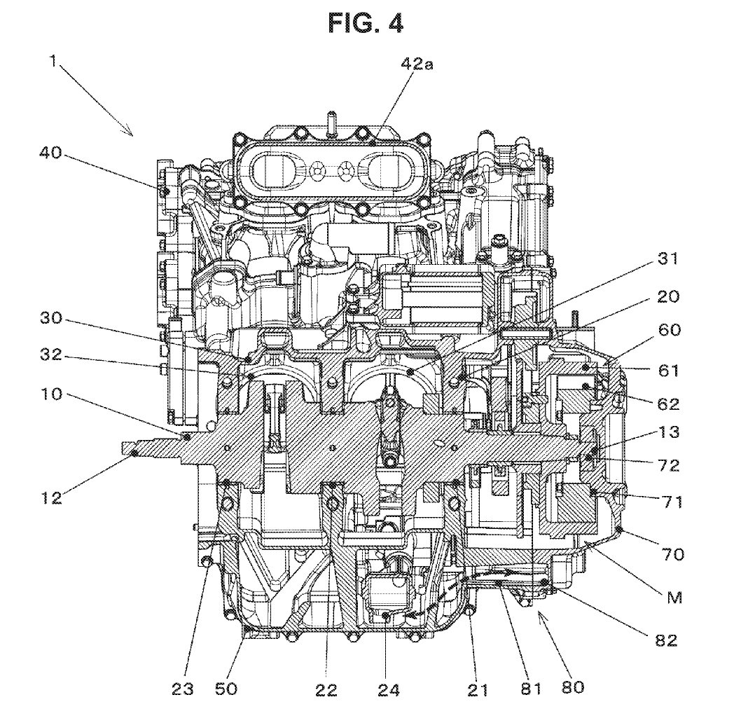

FIG. 4 is an arrow cross-sectional view taken along IV-IV in FIG. 3.

An engine 1 includes a crankshaft 10, a crankcase 20, a cylinder block 30, a cylinder head 40, an oil pan 50, a magneto 60, a magneto cover 70, a sub oil pan 80, and the like.

The crankcase 20, the cylinder block 30, the cylinder head 40, the oil pan 50, and the magneto cover 70 are cast, for example, from aluminum-based alloy, and then undergo predetermined machining.

The crankshaft 10 is an output axis of the engine 1, and is coupled with a piston (not illustrated) via a connecting rod 11.

The big end of the connecting rod 11 is swingably coupled with a crank pin of the crankshaft 10.

The small end of the connecting rod 11 is coupled with a piston (not illustrated) via a piston pin.

The crankshaft 10 is, for example, cast or forged and roughly molded from a steel-based material, and then has its axis, end face, oil groove, and the like undergo predetermined machining

The crankshaft 10 has journals that are formed in the middle rotatably supported by three main bearings 21 to 23 separately disposed on the crankcase 20 in the axial direction, and includes crank pins and crank webs of a first cylinder and a second cylinder between the respective main bearings 21 to 23.

An end 12 of the crankshaft 10 protrudes from the crankcase 20, and is coupled with an input axis of a transmission (not illustrated).

The other end 13 of the crankshaft 10 protrudes from the crankcase 20, and is disposed in the magneto cover 70.

A rotor magnet 61 of the magneto 60, a drive gear 15 of a balance shaft 14, a crank sprocket 16 used to drive a timing chain 17, a sprocket 18 used to drive an oil pump 33, and the like are provided in the vicinity of the end 13 in order as seen from the end 13.

The balance shaft 14 is provided above the crankshaft 10, and can rotate around the rotation center axis parallel to the crankshaft 10.

The balance shaft 14 includes a fan-shaped weight projecting from the rotation axis in the radial direction, and the fan-shaped weight rotates in synchronization with the rotation of the crankshaft 10 to counteract the vibration of the engine 1.

The crankcase 20 is a part like a container that houses and supports the crankshaft 10, the balance shaft 14, and the like, and includes the main bearings 21, 22, and 23, which rotatably support the crankshaft 10.

The crankcase 20 is structured as two pieces across the crankshaft 10.

The upper half of the crankcase 20 is integrated with the cylinder block 30.

The lower half of the crankcase 20 includes the rotation center axis of the crankshaft 10, and is joined and fastened to the upper half on the junction surface along a plane substantially orthogonal to the axes of cylinder sleeves 31 and 32.

The end of the lower half of the crankcase 20 opposite to the cylinder block 30 has an opening that communicates with the inside of the oil pan 50.

The lower part of the crankcase 20 includes a strainer 24 that is an inlet of the oil pump 33, which sucks oil reserved in the lower parts of the crankcase 20 and the oil pan 50.

The cylinder block 30 is a block member including the cylinder sleeves 31 and 32 of the first cylinder and the second cylinder in parallel.

As illustrated in FIG. 2, the axes of the cylinder sleeves 31 and 32 are inclined with the cylinder head 40 positioned diagonally above the crankcase 20.

The lower area (exhaust side) of the cylinder block 30 includes the oil pump 33 and an oil filter 34.

The oil pump 33 is driven by the crankshaft 10 via a chain, and pressures and pumps the oil sucked up from the strainer 24 to each part of the engine 1.

The oil filter 34 filters the oil with filter paper, and removes an undesired thing.

The cylinder head 40 is fastened to the end of the cylinder block 30 opposite to the crankcase 20.

The cylinder head 40 includes a combustion chamber 41, an inlet port 42, an exhaust port 43, an inlet camshaft 44, an exhaust camshaft 45, an ignition plug attachment part 46, an injector 47, and the like.

The combustion chamber 41 constitutes space to combust an air-fuel mixture in in cooperation with the crown surface of a piston (not illustrated) and the cylinder sleeves 31 and 32.

Examples of the combustion chamber 41 include a pent-roof combustion chamber formed by depressing the surface of the cylinder head 40 closer to the cylinder block 30.

An inlet port 42 is connected with the intake manifold 42a, and is a passage through which the air-fuel mixture is introduced to the combustion chamber 41. Each cylinder is provided with the two inlet ports 42 above the cylinder head 40.

The exhaust port 43 is a passage through which combusted gas is discharged from the combustion chamber 41, and each cylinder is provided the two exhaust ports 43 below the cylinder head 40.

Each cylinder is provided with two inlet valves and exhaust valves at the respective inlet ports 42 and exhaust ports 43 (one inlet valve and exhaust valve for each port), and each port is opened and closed at predetermined valve timing.

The inlet camshaft 44 and the exhaust camshaft 45 are rotation axes including cam lobes that drive the inlet valve and the outlet valve, respectively. The inlet camshaft 44 and the exhaust camshaft 45 are driven by the timing chain 17 wound between the inlet camshaft 44 and the exhaust camshaft 45 and the crank sprocket 16, thereby rotating cam sprockets 44a and 45a provided at the respective ends at ½ rotation speed of the crankshaft 10 in synchronization with each other.

The ignition plug attachment part 46 is a base to which an ignition plug that emits a spark at predetermined ignition time is attached in a manner that an electrode is disposed at the center of the combustion chamber 41.

The ignition plug attachment part 46 has a screw hole, a bearing surface, and the like to which a screw of the ignition plug is fastened.

The injector 47 injects gasoline, or fuel, into the inlet port 42 at predetermined injection time to generate an air-fuel mixture.

A water jacket that is a passage through which coolant flows is formed in an area around the cylinder sleeves 31 and 32 in the vicinity of the end of the cylinder block 30 closer to the cylinder head 40, and an area around the combustion chamber 41 and the exhaust port 43 in the cylinder head 40.

The oil pan 50 is a member like a container that is attached to plug the opening of the lower half of the crankcase 20 (opposite to the cylinder block 30), and stores lubricant oil in cooperation with the lower part of the crankcase 20 (which forms an oil pan in cooperation with the lower part of the crankcase 20 in a broad sense).

The oil pan 50 is joined, fastened, and fixed to the crankcase 20 on the junction surface formed along a plane substantially parallel to the junction surface of the upper and lower halves of the crankcase 20.

The magneto 60 is a power generation mechanism that generates direct-current power while the engine 1 is driven (the crankshaft 10 is rotated).

The magneto 60 includes the rotor magnet 61, a stator coil 62, and the like.

The rotor magnet 61 is a part like a pulley that is fastened and fixed to the end 13 of the crankshaft 10.

The rotor magnet 61 is formed by protruding a cylindrical part substantially concentric with the crankshaft 10 in the direction opposite to the crankcase 20 from the outer circumferential edge of a disc-shaped part projecting like a flange from the crankshaft 10 in the outer diameter direction.

Permanent magnets are arranged in a predetermined pattern on the inner circumferential surface of the cylindrical part of the rotor magnet 61 in the circumferential direction.

The stator coil 62 is inserted into the cylindrical part of the rotor magnet 61 in the inner diameter direction, and coils having a U-phase, a V-phase, and a W-phase are sequentially arranged on the outer circumferential surface in the circumferential direction to face the permanent magnets of the rotor magnet 61 with the narrowest intervals therebetween.

The coils having each phase have windings around the iron cores.

The stator coil 62 is fixed to the crankcase 20 via the magneto cover 70.

The magneto cover 70 is a member like a container that is provided at the end of the crankcase 20 closer to the magneto 60, and houses the magneto 60.

The magneto cover 70 constitutes a magneto chamber M in cooperation with an area adjacent to the crankcase 20.

The magneto cover 70 is formed like a cup that has an opening on the side closer to the crankcase 20, and has the end closer to the crankcase 20 joined and fastened on the junction surface along a plane orthogonal to the rotation axis of the crankshaft 10.

The magneto cover 70 includes a base 71 to which the stator coil 62 of the magneto 60 is attached.

The base 71 is formed by projecting the center of the end face of the magneto cover 70 opposite to the crankcase 20 toward the crankcase 20.

The center of the base 71 includes a sub-bearing 72 that rotatably supports the end 13 of the crankshaft 10.

The inside of the magneto cover 70 communicates with the inside of the crankcase 20, and can let in oil.

As illustrated in FIG. 4, the wall surface of the crankcase 20 on which the main bearing 21 is formed can block oil flowing toward the magneto cover 70 and hold a predetermined amount of oil.

As a result, the inside of the magneto cover 70 always holds such an amount of oil that the outer circumferential surface of the rotor magnet 61 of the magneto 60 comes into contact with the surface of the oil.

The oil reserved here is scooped up by the crack sprocket 16 and the like, and used for lubrication of the timing chain 17 and the like. In addition, the oil is scooped up by the outer circumferential surface of the rotor magnet 61, and used to cool (oil-cool) the rotor magnet 61 and the stator coil 62.

The sub oil pan 80 is space that is provided below the magneto chamber M and communicates with the crankcase 20 and the oil pan 50, and can let in oil.

The sub oil pan 80 projects from the crankcase 20, which constitutes the magneto chamber M, and an area of the lower surface of the magneto cover 70 in contact with oil reserved in the magneto chamber M, so that the bottom of the magneto chamber M serves as the upper surface of the sub oil pan 80. The bottom of the magneto chamber M serves as a partition wall interposed between the magneto chamber M and the sub oil pan 80.

The sub oil pan 80 is laterally disposed (horizontally offset) with respect to the oil pan 50.

The sub oil pan 80 includes two pieces: a half 81 integrated with the crankcase 20; and a half 82 integrated with the magneto cover 70.

The halves 81 and 82 are joined to each other on the junction surface formed on the same plane as the junction surface of the crankcase 20 and the magneto cover 70.

As illustrated in FIG. 4, the end of the half 81 integrated with the crankcase 20 which is opposite to the magneto cover 70 communicates with the inside of the crankcase 20, and oil can flow between the sub oil pan 80, the crankcase 20, and the oil pan 50 as illustrated by the dashed arrow in FIG. 4.

The sub oil pan 80 makes it possible to reserve an enough amount of oil without enlarging the dimensions of the oil pan 50 and the lower half of the crankcase 20 in the depth direction (vertical direction) in the present implementation.

Even if the engine 1 is inclined with the sub oil pan 80 positioned down, the use of the sub oil pan 80 as a buffer can prevent the level of oil in the crankcase 20 from rising, and prevent the surface of the oil from interfering with the crankshaft 10 and the like.

The stator coil 62 of the magneto 60 has a high temperature while the stator coil 62 is in operation to generate power. Accordingly, the temperature of oil reserved in the magneto chamber M reaches, for example, some 170 to 180 degrees Celsius in some cases. However, it is possible to cool the stator coil 62 with the oil having, for example, temperatures up to some 140 degrees Celsius in the sub oil pan 80 via the bottom of the magneto chamber M, so that the magneto 60 can be efficiently cooled.

According to the implementation as described above, the following advantageous effects can be attained.

(1) Allowing both the oil pan 50 and the sub oil pan 80 to reserve oil makes it possible to reserve an enough amount of oil without enlarging the depth (vertical dimension) of the oil pan 50.

In addition, the use of the sub oil pan 80 as a buffer for the inclined engine 1 can prevent the level of oil in the crankcase 20 from rising, and prevent the surface of the oil from interfering with a variety of rotary parts such as the crankshaft 10, decreasing oil mist, which causes oil spout.

Thermal conduction from oil that has a relatively high temperature and is reserved in the magneto chamber M to oil having a relatively low temperature in the sub oil pan 80 cools the oil in the magneto chamber M, so that the magneto 60 can be efficiently cooled and the reliability and durability can be increased.

It is further possible to prevent degradation due to oil heated too much in the magneto chamber M.

(2) It is possible to attain the above-described advantageous effects without increasing the number of parts by forming the sub oil pan 80 at a point where the crankcase 20 is joined to the magneto cover 70, and integrating a part (half 81) of the sub oil pan 80 and the other (half 82) of the sub oil pan 80 therewith.

It is possible to increase the rigidity of the engine 1 by structuring the crankcase 20 and the magneto cover 70 with the cross sections at the split position substantially closed.

According to the present implementation as described above, it is possible to provide an engine that can increase the resistance to inclination and efficiently cool the magneto.

### (Modification)

The present invention is not limited to the above-described implementation. Various modifications and variations are possible, and they also fall within the technical scope of the present invention.

For example, it is possible to change, as needed, the shape, structure, material, manufacturing method, disposition, and quantity of members that constitute the engine. Any cylinder layout, method for driving a valve, and application can be adopted.

The sub oil pan is provided on only one side (side closer to the magneto chamber) of the crankcase in the implementation. However, if there is space to implement a sub oil pan in, a sub oil pan can be provided on the other side of the crankcase.

Although the preferred implementation of the present disclosure has been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

1. An engine comprising:
a crankcase that houses a crankshaft;
an oil pan that is provided at a lower part of the crankcase and reserves an oil;
a magneto chamber that is provided adjacent to one of ends of the crankcase in a rotation axis direction of the crankshaft, houses a magneto, and reserves an oil in a lower part of the magneto chamber; and
a sub oil pan that is horizontally offset with respect to the oil pan, is disposed under the magneto chamber and adjacent to the magneto chamber via a partition wall, and is capable of letting in an oil from the oil pan.

2. The engine according to claim 1,
wherein a part of the sub oil pan is integrated with a magneto cover that constitutes an outer wall of the magneto chamber, and another part of the sub oil pan is integrated with the crankcase.
